(19) United States
(12) Patent Application Publication
(10) Pub. No.: US 2025/0259274 A1
(43) Pub. Date: Aug. 14, 2025

(54) SYSTEM AND METHOD FOR DEEP EQUILIBIRUM APPROACH TO ADVERSARIAL ATTACK OF DIFFUSION MODELS

(71) Applicant: Robert Bosch GmbH, Stuttgart (DE)

(72) Inventors: Ivan BATALOV, Pittsburgh, PA (US); Wan-Yi LIN, Wexford, PA (US); Chaithanya Kumar MUMMADI, Pittsburgh, PA (US)

(21) Appl. No.: 18/441,337

(22) Filed: Feb. 14, 2024

(51) Int. Cl. G06T 5/60; G06T 5/70; G06T 5/73

(52) U.S. Cl. CPC G06T 5/60; G06T 5/70; G06T 5/73; G06T 2207/20084

(57) ABSTRACT

A method for attacking a neural network that includes receiving an input data that includes an image and ground truth label, adding a pre-determined amount of noise to the image, denoising the noisy image utilizing a diffusion model that includes a deep equilibrium root solver, determining a first gradient of the denoised image with respect to the input data including at least the image, wherein the first gradient is associated with the diffusion model, utilizing the denoised image at downstream model, outputting a predicated label associated with the denoised image, determining a loss utilizing with the predicted label and the ground truth label, determining a second gradient associated with the downstream model utilizing at least the loss, and outputting an aggregate gradient that represents an error of the neural network output utilizing the predicted label, wherein the aggregate gradient is calculated utilizing the first gradient and the second gradient.

### TECHNICAL FIELD

The present disclosure relates to machine learning, including embodiments that relate to models that may experience adversarial attacks.

### BACKGROUND

Image classifiers are prepended with diffusion model to defend against Lp norm adversarial attacks. Diffusion models involve iterative noising-denoising process with large number of steps. Generation of effective adversarial input images for testing the adversarial robustness of this diffusion-classification pipeline relies on calculating accurate gradients of the noising-denoising process, which is memory-prohibitive using the backpropagation method. In this prior work, authors calculated gradients by solving the adjoint problem using a Stochastic Differential Equation (SDE) solver. Here, the authors claim that such method can approximate the actual gradients, and adversarial perturbations generated by such gradients could result in effective adversarial attack for diffusion models. They show that the diffusion models are robust against such adversarial attacks. However, the SDE solvers may approximate imprecise gradients that yield sub-optimal adversarial perturbations lowering the effectiveness of the adversarial attack and overestimating robustness of the diffusion models.

### SUMMARY

A first embodiment discloses a computer-implemented method for attacking a neural network that includes receiving an input data, wherein the input data includes at least an image and a corresponding ground truth label, adding a pre-determined amount of noise to the image to create a noisy image, denoising the noisy image utilizing a diffusion model that includes a deep equilibrium root solver configured to generate a denoised image, determining a first gradient of the denoised image with respect to the input data including at least the image, wherein the first gradient is associated with the diffusion model, utilizing the denoised image at downstream model of the neural network, outputting a predicated label associated with the denoised image, determining a loss utilizing with the predicted label and the ground truth label, determining a second gradient associated with the downstream model utilizing at least the loss, and outputting an aggregate gradient that represents an error of the neural network output utilizing the predicted label, wherein the aggregate gradient is calculated utilizing at least the first gradient and the second gradient.

A second embodiment discloses, a system that includes a controller configured to receive an input data, wherein the input data includes at least an image and a corresponding ground truth label, add a noise to the image to create a noisy image, denoise the noisy image utilizing a diffusion model that includes a deep equilibrium root solver configured to generate a denoised image, determine a first gradient of the denoised image, wherein the first gradient is associated with the diffusion model, utilizing the denoised image at downstream model of the neural network, output a predicated label associated with the denoised image, determine a loss utilizing the predicted label and the ground truth label, determine a second gradient associated with the downstream model utilizing at least the loss, and output an aggregate gradient that represents an error of the neural network output utilizing the predicted label, wherein the gradient is calculated utilizing at least the first gradient and the second gradient.

A third embodiment discloses, a computer-implemented method for attacking a neural network that includes receiving an image, adding a pre-determined amount of noise to the image to create a noisy image, denoising the noisy image utilizing a diffusion model that includes a deep equilibrium root solver configured to generate a denoised image, determining a first gradient of the denoised image, wherein the first gradient is associated with the diffusion model, utilizing the denoised image at downstream model of the neural network, outputting a predicated label associated with the denoised image, determining a loss utilizing at least the predicted label, determining a second gradient associated with the downstream model utilizing at least the loss, and outputting an aggregate gradient that represents an error of the neural network output utilizing the predicted label, wherein the gradient is calculated utilizing at least the first gradient and the second gradient.

### BRIEF DESCRIPTION OF THE DRAWINGS

FIG. 1 shows a system for training a neural network, according to an embodiment.

FIG. 2 shows a computer-implemented method for training and utilizing a neural network, according to an embodiment.

FIG. 3 shows an embodiment of a diffusion model utilize as an adversarial defense.

FIG. 4 shows an embodiment of computing gradient utilizing at least a diffusion model.

FIG. 5 depicts a schematic diagram of an interaction between a computer-controlled machine and a control system, according to an embodiment.

FIG. 6 depicts a schematic diagram of the control system of FIG. 5 configured to control a vehicle, which may be a partially autonomous vehicle, a fully autonomous vehicle, a partially autonomous robot, or a fully autonomous robot, according to an embodiment.

FIG. 7 depicts a schematic diagram of the control system of FIG. 5 configured to control a manufacturing machine, such as a punch cutter, a cutter or a gun drill, of a manufacturing system, such as part of a production line.

FIG. 8 depicts a schematic diagram of the control system of FIG. 5 configured to control a power tool, such as a power drill or driver, that has an at least partially autonomous mode.

FIG. 9 depicts a schematic diagram of the control system of FIG. 5 configured to control an automated personal assistant.

FIG. 10 depicts a schematic diagram of the control system of FIG. 5 configured to control a monitoring system, such as a control access system or a surveillance system.

FIG. 11 depicts a schematic diagram of the control system of FIG. 5 configured to control an imaging system, for example an MRI apparatus, x-ray imaging apparatus or ultrasonic apparatus.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

Current system may have errors in calculating gradients through a diffusion model using an SDE solver and thus have an effect on the performance of adversarial attacks. Such system may be able to make attacks more effective by using a surrogate method, which entails approximating the gradient of a many-step denoising process with the gradient of a denoising process with fewer, but larger, steps. In contrast, the advantage of our the proposed approach as disclosed below is that such a system and method can calculate gradients of a denoising process with more denoising steps and make the adversarial attack even more effective against diffusion models.

White box attack is the type of an attack that has access to the model's internal parameters, which it uses to find adversarial input perturbations, e.g. the perturbations that are constrained in norm and that, when added to the input sample, maximize the model's output error for that particular sample. For white box attacks to be effective, they need precise gradients of the model's output with respect to the input.

In case of attacking image analysis pipelines that contain a diffusion model, e.g. a diffusion model followed by an image classifier, the gradient of the denoising diffusion probalistic model (DDPM) classifier with respect to the input image is needed. Normally, such gradient is calculated by backpropagating through the computational graph—a feature that is available in any deep learning framework. However, as the DDPM-driven denoising process contains multiple (typically more than 50) steps, backpropagating through the whole chain of steps is prohibitively memory expensive. During adversarial purification, the diffusion model first either sequentially adds noise to the image in T steps or adds equivalent amount of noise in one shot. The denoising process consists of sequential removal of the noise added to the image in T steps. At each step t the diffusion model estimates the noise ∈_{θ}^{(t)}(xₜ) added to the image at the step t as a function of the image xₜ, and xₜ₋₁ is produced according to the following equation:

$$\begin{matrix}{x}_{t - 1} = \sqrt{{α}_{t - 1}} ( \frac{{x}_{t} - \sqrt{1 - {α}_{t}} {ϵ}_{θ}^{( t )} ( {x}_{t} )}{\sqrt{{α}_{t}}} ) + \sqrt{1 - {α}_{t - 1} - {σ}_{t}^{2}} \cdot {e}_{θ}^{( t )} ( {x}_{t} ) + {σ}_{t} {ϵ}_{t} , \\ {σ}_{t} = η \sqrt{\frac{1 - {α}_{t - 1}}{1 - {α}_{t}}} \cdot \sqrt{( 1 - \frac{{α}_{t}}{{α}_{t}} )}\end{matrix}$$

The denoising process is repeated from t=T−1 until t=0, yielding x₀—the denoised image. While the denoising process can be shortened by using larger steps (step size of 1 is used in the equations above as an example) and thus fewer number of steps, it's been shown that it makes the adversarial purification process less robust. However, normal backpropagation through the many-step denoising sequence is not possible due to GPU memory constrains.

Diffusion models have recently been shown to achieve impressive results in improving adversarial robustness of pre-trained image classifiers by “purifying” the adversarially perturbed images before they are fed into the classifier, outcompeting adversarially trained models. They do so by first adding Gaussian noise to the image and then sequentially removing it in a multi-step process. The goal of this denoising process is to remove the adversarial perturbation along with the Gaussian noise, recovering the original image. In order to accurately estimate the robustness of this approach, one needs to obtain full gradients of the classifier's output with respect to the input image before it is passed to the diffusion model. To calculate them, both the gradient of the classifier's output with respect to the denoised image and the gradient of the denoised image with respect to the input image are needed. While the first can be easily obtained via backpropagation through the classifier's computational graph, the second is harder to obtain due to the multi-step nature of the denoising process, which makes backpropagation though it prohibitively memory expensive. Some systems may calculate the gradients of the denoising process by solving the adjoint problem using a stochastic differential equation (SDE) solver and achieved remarkably high robust accuracy with this approach. However, as this method could potentially yield imprecise gradients, it was not clear if the high robustness was due to the inherent robustness of the diffusion models or due to the errors in gradient calculation. Prior systems proposed a surrogate method of calculating the gradients, where the gradients of a fewer step denoising process were used to approximate the gradients in a denoising process with a higher number of steps. This resulted in a significantly lower robust accuracy, indicating that the surrogate method achieves more precise gradients that the adversary can use to more effectively attack the diffusion model.

In one embodiment, in order to calculate gradients of the denoised image with respect to the input image, the system may employ deep equilibrium representation of the stochastic denoising diffusion implicit models (DEQ-sDDIM), which may lower memory demand allowing the system to use more denoising steps compared to the sequential denoising processes. Although the gradient of the denoised image with respect to the original image calculated with this approach is an approximation, the system may show that it leads to better performance of white box adversarial attacks, including projected gradient descent (PGD) and AutoAttack methods, when compared to the prior approaches. With such a system and method described below, it can also be used in adversarial training of diffusion models, resulting in models that are more robust against adversarial attacks.

The system may calculate such gradients using a previously described deep equilibrium (DEQ) approach utilizing diffusion models. Instead of denoising the image sequentially, the denoising process is rewritten as a fixed point equation:

$$[ \begin{matrix}{x}_{T - 1} \\ {x}_{T - 2} \\ ⋮ \\ {x}_{0}\end{matrix} ] = [ \begin{matrix}h ( {x}_{T} ) \\ h ( {x}_{T - 1 : T} ) \\ ⋮ \\ h ( {x}_{1 : T} )\end{matrix} ]$$

Or in the vector form,

$${x}_{0 : T - 1} = \tilde{h} ( {x}_{0 : T - 1} ; {x}_{T} ) ,$$

where h(x_{t:T})=xₜ₋₁ is the function performing one step of the denoising. The above system of equations may represent a DEQ with x_{T} as input injection. The system can simultaneously solve for the roots of this system of equations through existing solvers like Anderson acceleration. Let g(x_{0:T-1}; x_{T})=\tilde{h}(x_{0:T-1}; x_{T})−x_{0:T-1}, then the system may have

$${x}_{0 : T}^{*} = RootSolver ( g ( {x}_{0 : T - 1} ; {x}_{T} ) )$$

Equations above describe the deterministic denoising process, for example, given the initial noisy image x_{T}, the predicted denoised image x₀ may be determined with certainty. The stochastic version of the denoising process, which involves adding extra noise at each denoising step, can also be implemented with DEQ using

$${x}_{0 : T}^{*} = RootSolver ( g ( {x}_{0 : T - 1} ; {x}_{T} , {ϵ}_{1 : T} ) )$$

Where ∈_{1:T}˜N(0, 1) represents the input injected noises.

To calculate the gradient of the loss function L with respect to the input image x_{T}, the following approximation can be used:

$$\frac{\partial L}{\partial {x}_{T}} = - \frac{\partial L}{\partial {x}_{0}} M \frac{\partial \tilde{h} ( {x}_{0 : T - 1} ; {x}_{T} )}{\partial {x}_{T}} \qquad ( 1 )$$

Where M is an approximation of

$${J}_{{g}_{θ}}^{- 1} {\vert}_{{x}_{0 : T}^{*}}$$

the inverse Jacobian of g(x_{0:T-1}, x_{T}). It's been shown that M=I, i.e. 1-step gradient, performs reasonably well. To further improve the accuracy of the gradient, >1 step gradient can be calculated, although at an increased computational and memory cost. Additionally, a damping factor t can be added for improved convergence, making the final equation as follows:

$${x}_{0 : T}^{*} = RootSolver ( g ( {x}_{0 : T - 1} ; {x}_{T} ; {ϵ}_{1 : T} ) )$$

For i in range (n_steps):

$${x}_{0 : T}^{*} = τ \cdot \tilde{h} ( {x}_{0 : T - 1}^{*} ; {x}_{T}^{*} ) + ( 1 - τ ) \cdot {x}_{0 : T}^{*} \qquad ( Equation 2 )$$

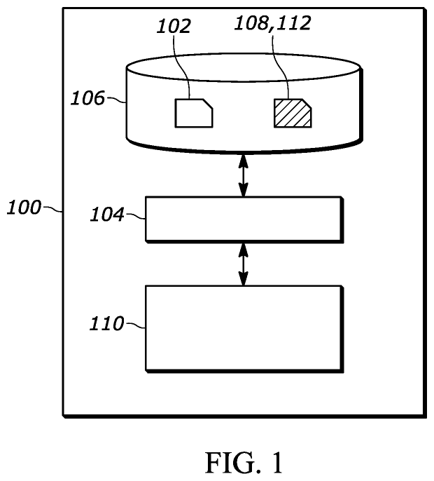

Reference is now made to the embodiments illustrated in the Figures, which can apply these teachings to a machine learning model or neural network. FIG. 1 shows a system 100 for training a neural network, e.g. a deep neural network. The system 100 may comprise an input interface for accessing training data 102 for the neural network. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the neural network which may be accessed by the system 100 from the data storage 106. It will be appreciated, however, that the training data 102 and the data representation 108 of the untrained neural network may also each be accessed from a different data storage, e.g., via a different subsystem of the data storage interface 104. Each subsystem may be of a type as is described above for the data storage interface 104. In other embodiments, the data representation 108 of the untrained neural network may be internally generated by the system 100 on the basis of design parameters for the neural network, and therefore may not explicitly be stored on the data storage 106. The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive as input an output of a previous layer, or for a first layer of the stack of layers, an initial activation, and a part of the input of the stack of layers. The processor subsystem 110 may be further configured to iteratively train the neural network using the training data 102. Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network. The system 100 may further comprise an output interface for outputting a data representation 112 of the trained neural network, this data may also be referred to as trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the ‘untrained’ neural network may during or after the training be replaced, at least in part by the data representation 112 of the trained neural network, in that the parameters of the neural network, such as weights, hyperparameters and other types of parameters of neural networks, may be adapted to reflect the training on the training data 102. This is also illustrated in FIG. 1 by the reference numerals 108, 112 referring to the same data record on the data storage 106. In other embodiments, the data representation 112 may be stored separately from the data representation 108 defining the ‘untrained’ neural network. In some embodiments, the output interface may be separate from the data storage interface 104, but may in general be of a type as described above for the data storage interface 104.

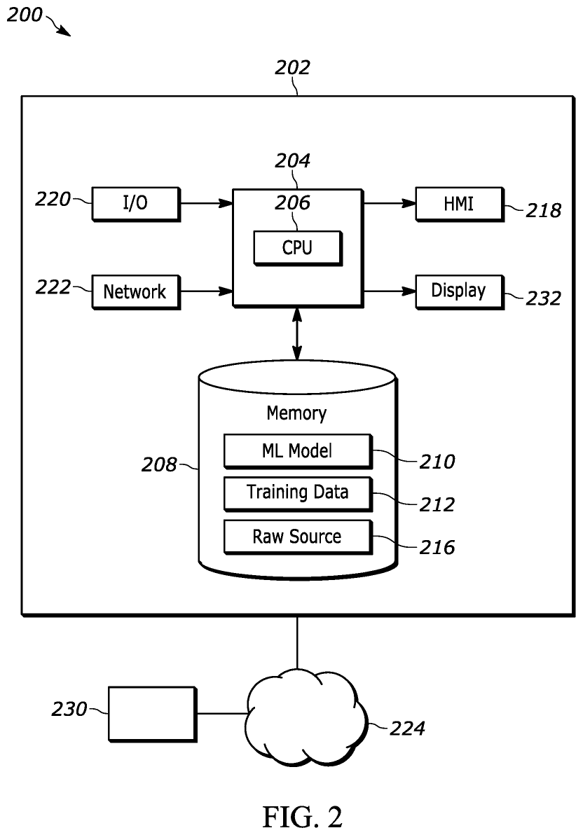

The structure of the system 100 is one example of a system that may be utilized to train the image-to-image machine-learning model and the mixer machine-learning model described herein. Additional structure for operating and training the machine-learning models is shown in FIG. 2.

FIG. 2 depicts a system 200 to implement the machine-learning models described herein, for example the image-to-image machine-learning model, the mixer machine-learning model, and the pre-trained reference model described herein. The system 200 can be implemented to perform calculating gradients utilizing deep equilibrium processes described herein. The system 200 may include at least one computing system 202. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction set such as one of the x86, ARM, Power, or MIPS instruction set families. During operation, the CPU 206 may execute stored program instructions that are retrieved from the memory unit 208. The stored program instructions may include software that controls operation of the CPU 206 to perform the operation described herein. In some examples, the processor 204 may be a system on a chip (SoC) that integrates functionality of the CPU 206, the memory unit 208, a network interface, and input/output interfaces into a single integrated device. The computing system 202 may implement an operating system for managing various aspects of the operation. While one processor 204, one CPU 206, and one memory 208 is shown in FIG. 2, of course more than one of each can be utilized in an overall system.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine-learning model 210 or algorithm, a training dataset 212 for the machine-learning model 210, raw source dataset 216.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud.

The external network 224 may be referred to as the world-wide web or the Internet. The external network 224 may establish a standard communication protocol between computing devices. The external network 224 may allow information and data to be easily exchanged between computing devices and networks. One or more servers 230 may be in communication with the external network 224.

The computing system 202 may include an input/output (I/O) interface 220 that may be configured to provide digital and/or analog inputs and outputs. The I/O interface 220 is used to transfer information between internal storage and external input and/or output devices (e.g., HMI devices). The I/O 220 interface can includes associated circuitry or BUS networks to transfer information to or between the processor(s) and storage. For example, the I/O interface 220 can include digital I/O logic lines which can be read or set by the processor(s), handshake lines to supervise data transfer via the I/O lines; timing and counting facilities, and other structure known to provide such functions. Examples of input devices include a keyboard, mouse, sensors, etc. Examples of output devices include monitors, printers, speakers, etc. The I/O interface 220 may include additional serial interfaces for communicating with external devices (e.g., Universal Serial Bus (USB) interface).

The computing system 202 may include a human-machine interface (HMI) device 218 that may include any device that enables the system 200 to receive control input. Examples of input devices may include human interface inputs such as keyboards, mice, touchscreens, voice input devices, and other similar devices. The computing system 202 may include a display device 232. The computing system 202 may include hardware and software for outputting graphics and text information to the display device 232. The display device 232 may include an electronic display screen, projector, printer or other suitable device for displaying information to a user or operator. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

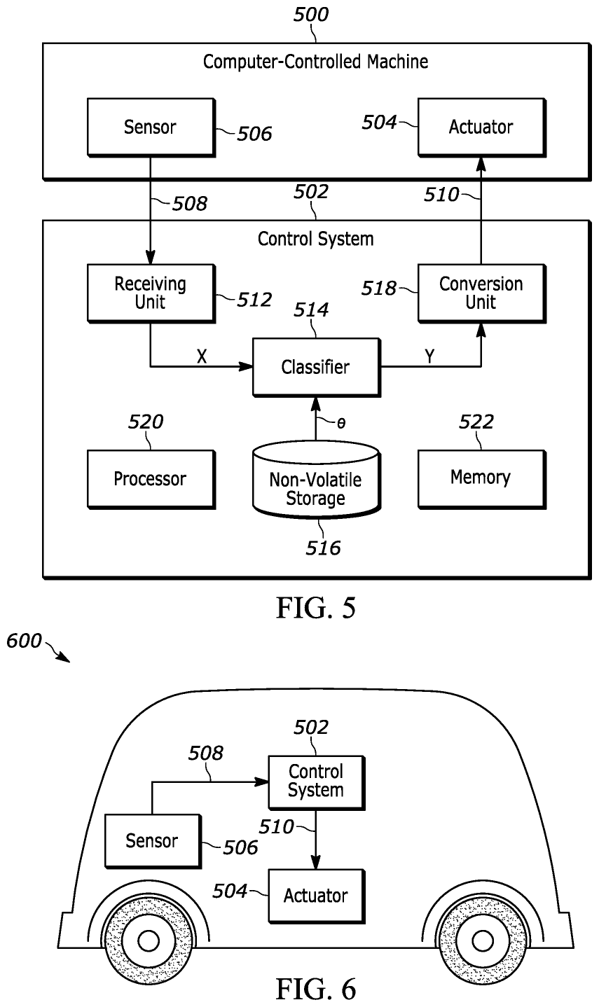

The system 200 may implement a machine-learning algorithm 210 that is configured to analyze the raw source dataset 216. The raw source dataset 216 may include raw or unprocessed sensor data that may be representative of an input dataset for a machine-learning system. The raw source dataset 216 may include video, video segments, images, text-based information, audio or human speech, time series data (e.g., a pressure sensor signal over time), and raw or partially processed sensor data (e.g., radar map of objects). Several different examples of inputs are shown and described with reference to FIGS. 5-11. In some examples, the machine-learning algorithm 210 may be a neural network algorithm (e.g., deep neural network) that is designed to perform a predetermined function. For example, the neural network algorithm may be configured in automotive applications to identify street signs or pedestrians in images. The machine-learning algorithm(s) 210 may include algorithms configured to operate the image-to-image machine-learning model, the mixer machine-learning model, and the pre-trained reference model described herein.

The computer system 200 may store a training dataset 212 for the machine-learning algorithm 210. The training dataset 212 may represent a set of previously constructed data for training the machine-learning algorithm 210. The training dataset 212 may be used by the machine-learning algorithm 210 to learn weighting factors associated with a neural network algorithm. The training dataset 212 may include a set of source data that has corresponding outcomes or results that the machine-learning algorithm 210 tries to duplicate via the learning process. In this example, the training dataset 212 may include input images that include an object (e.g., a street sign). The input images may include various scenarios in which the objects are identified.

The machine-learning algorithm 210 may be operated in a learning mode using the training dataset 212 as input. The machine-learning algorithm 210 may be executed over a number of iterations using the data from the training dataset 212. With each iteration, the machine-learning algorithm 210 may update internal weighting factors based on the achieved results. For example, the machine-learning algorithm 210 can compare output results (e.g., a reconstructed or supplemented image, in the case where image data is the input) with those included in the training dataset 212. Since the training dataset 212 includes the expected results, the machine-learning algorithm 210 can determine when performance is acceptable. After the machine-learning algorithm 210 achieves a predetermined performance level (e.g., 100% agreement with the outcomes associated with the training dataset 212), or convergence, the machine-learning algorithm 210 may be executed using data that is not in the training dataset 212. It should be understood that in this disclosure, “convergence” can mean a set (e.g., predetermined) number of iterations have occurred, or that the residual is sufficiently small (e.g., the change in the approximate probability over iterations is changing by less than a threshold), or other convergence conditions. The trained machine-learning algorithm 210 may be applied to new datasets to generate annotated data.

The machine-learning algorithm 210 may be configured to identify a particular feature in the raw source data 216. The raw source data 216 may include a plurality of instances or input dataset for which supplementation results are desired. For example, the machine-learning algorithm 210 may be configured to identify the presence of a road sign in video images and annotate the occurrences. The machine-learning algorithm 210 may be programmed to process the raw source data 216 to identify the presence of the particular features. The machine-learning algorithm 210 may be configured to identify a feature in the raw source data 216 as a predetermined feature (e.g., road sign). The raw source data 216 may be derived from a variety of sources. For example, the raw source data 216 may be actual input data collected by a machine-learning system. The raw source data 216 may be machine generated for testing the system. As an example, the raw source data 216 may include raw video images from a camera.

In an example, the raw source data 216 may include image data representing an image. Applying the machine-learning algorithms (e.g., image-to-image machine learning model, mixer machine-learning model, and pre-trained reference model) described herein, the output can be a quantized version of the input image. Given the above description of the machine-learning models, along with the structural examples of FIGS. 1-2 configured to carry out the models.

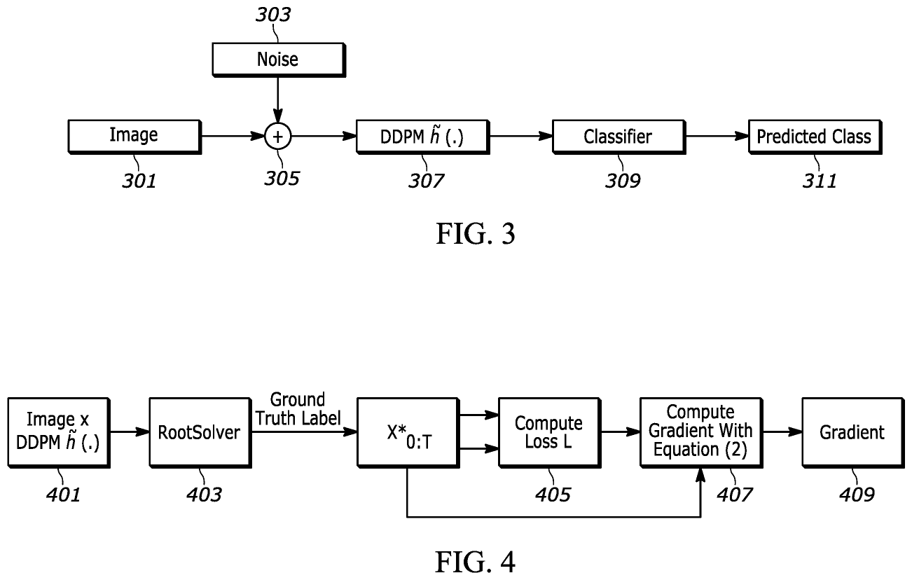

FIG. 3 illustrates a flow-chart associated with the following embodiments. In such an embodiment, a dataset containing images and their corresponding labels to be predicted may be a requirement. The system may include a neural network may include of a diffusion model followed by an image analysis model (e.g. an image classifier). At step 301, the system may receive an input image from the dataset. The input image may include corresponding labels associated with an image. For example, if an image includes a picture of a lion, a data label associated with the image may state “LION.”

At step 303, a pre-determined amount of noise is generated. The noise will be added at step 305 to an image to generate a noisy image. The noisy image may undergo a denoising process using DEQ-sDDIM formulation. The denoised image is inputted into the image analysis model that outputs a predicted label for the image. The amount of noise may be assigned and adjusted based on the network. Thus, more or less noise may be added to the images to create a noisy image. The noise may include static, shadows, color or lighting imbalances, etc.

At step 307, the noisy image (which includes the added image and the noise), may be sent to the denoising diffusion probalistic model (DDPM). DDPM may be a type of generative model process. The system may compute the gradient of DDMPM with DEQ. The processes involved with the DDPM may be described in FIG. 4, as well as the above.

At step 309, the output of the DDPM may be sent to a classifier of the neural network. The classifier may be associated with a downstream model of the neural network. The output of the DDPM may include a computed gradients. The computed gradient may be utilized at the classifier to obtain a predicted class.

At step 311, the predicted class may be output by the classifier. The predicted class of the denoised image may attempted to identify a class of the image. The image label (ground truth) may be used to calculate the appropriate differentiable loss function that represent the error of the model's output. The approximate gradient of the loss function with respect to the input image may be calculated. The precision of the part of the gradient corresponding to image denoising is controlled using parameters n_steps and t. The gradient may be calculated using backpropagation algorithm.

The calculated gradient may be used to determine the adversarial perturbation ε, e.g. the perturbation bound by the chosen norm, e.g. ∥ε∥ₚ≤a, p=1,2 . . . , a∈R⁺, that maximizes the loss function. The adversarial examples can be used to test the robustness of a particular diffusion model+image analysis model pipeline by calculating the pipeline's performance on the adversarially perturbed images or to train either or both components of the pipeline to be more robust against adversarial attacks.

FIG. 4 illustrates a flow chart for computing a gradient of DDPM with DEQ.

At 401, the system may include an image x. The image may include a corresponding label as well as added noise prior to be added to the DDPM model. The image may be any type of image, including a sound image, a video image, a picture image, sonar image, Lidar image, radar image, etc. The image may be collected via various sensors in communication with the machine learning model.

At step 403, the system can simultaneously solve for the roots of this system of equations through existing solvers like Anderson acceleration. Let g(x_{0:T-1}; x_{T})=\tilde{h}(x_{0:T-1}; x_{T})−x_{0:T-1}, then the system may have

$${x}_{0 : T}^{*} = RootSolver ( g ( {x}_{0 : T - 1} ; {x}_{T} ) )$$

Such an equation may show a deterministic denoising process, for example, given the initial noisy image x_{T}, the predicted denoised image x₀ may be determined with certainty. The stochastic version of the denoising process, which involves adding extra noise at each denoising step, can also be implemented with DEQ using

$${x}_{0 : T}^{*} = RootSolver ( g ( {x}_{0 : T - 1} ; {x}_{T} ; {ϵ}_{1 : T} ) )$$

Where ∈_{1:T}˜N(0, 1) represents the input injected noises.

At step 405, the system may compute a loss associated with the denoised image. The loss may be determined utilizing the ground truth label (if applicable) and predicted label associated with the denoised image. If a ground truth label is not available, the predicted label may be sufficient to calculate the loss.

At step 407, the system may compute gradient with equation 2. To calculate the gradient of the loss function L with respect to the input image XT, the following approximation can be used:

$$\frac{\partial L}{\partial {x}_{T}} = - \frac{\partial L}{\partial {x}_{0}} M \frac{\partial \tilde{h} ( {x}_{0 : T - 1} ; {x}_{T} )}{\partial {x}_{T}} \qquad ( 1 )$$

Where M is an approximation of

$${J}_{{g}_{θ}}^{- 1} {\vert}_{{x}_{0 : T}^{*}}$$

the inverse Jacobian of g(x_{0:T-1}, x_{T}). It's been shown that M=I, i.e. 1-step gradient, performs reasonably well. To further improve the accuracy of the gradient, >1 step gradient can be calculated, although at an increased computational and memory cost. Additionally, a damping factor t can be added for improved convergence, making the final equation as follows:

$${x}_{0 : T}^{*} = RootSolver ( g ( {x}_{0 : T - 1} ; {x}_{T} ; {ϵ}_{1 : T} ) )$$

For i in range (n_steps):

$${x}_{0 : T}^{*} = τ \cdot \tilde{h} ( {x}_{0 : T - 1}^{*} ; {x}_{T}^{*} ) + ( 1 - τ ) \cdot {x}_{0 : T}^{*} \qquad ( Equation 2 )$$

At step 409, the aggregate gradient is output. The gradient may be output in response to an aggregated gradient output from both a down-stream model and a separate diffusion model. Thus the output of the denoising process (e.g. the denoised image) may calculated utilizing equation 2. The aggregate gradient may be utilized to determine the adversarial perturbation for both models (versus just a diffusion model or downstream model), for example the perturbation bound by the chosen norm that maximizes the loss function. The number of iterations may be pre-determined or a value may be set. The adversarial examples may be used to test the robustness of certain diffusional model that may be utilized with a certain image analysis model.

FIG. 5 depicts a schematic diagram of an interaction between a computer-controlled machine 500 and a control system 502. Computer-controlled machine 500 includes actuator 504 and sensor 506. Actuator 504 may include one or more actuators and sensor 506 may include one or more sensors. Sensor 506 is configured to sense a condition of computer-controlled machine 500. Sensor 506 may be configured to encode the sensed condition into sensor signals 508 and to transmit sensor signals 508 to control system 502. Non-limiting examples of sensor 506 include video, radar, LiDAR, ultrasonic and motion sensors. In one embodiment, sensor 506 is an optical sensor configured to sense optical images of an environment proximate to computer-controlled machine 500.

Control system 502 is configured to receive sensor signals 508 from computer-controlled machine 500. As set forth below, control system 502 may be further configured to compute actuator control commands 510 depending on the sensor signals and to transmit actuator control commands 510 to actuator 504 of computer-controlled machine 500.

As shown in FIG. 5, control system 502 includes receiving unit 512. Receiving unit 512 may be configured to receive sensor signals 508 from sensor 506 and to transform sensor signals 508 into input signals x. In an alternative embodiment, sensor signals 508 are received directly as input signals x without receiving unit 512. Each input signal x may be a portion of each sensor signal 508. Receiving unit 512 may be configured to process each sensor signal 508 to product each input signal x. Input signal x may include data corresponding to an image recorded by sensor 506.

Control system 502 includes a classifier 514. Classifier 514 may be configured to classify input signals x into one or more labels using a machine learning (ML) algorithm, such as a neural network described above. Classifier 514 is configured to be parametrized by parameters, such as those described above (e.g., parameter θ). Parameters θ may be stored in and provided by non-volatile storage 516. Classifier 514 is configured to determine output signals y from input signals x. Each output signal y includes information that assigns one or more labels to each input signal x. Classifier 514 may transmit output signals y to conversion unit 518. Conversion unit 518 is configured to covert output signals y into actuator control commands 510. Control system 502 is configured to transmit actuator control commands 510 to actuator 504, which is configured to actuate computer-controlled machine 500 in response to actuator control commands 510. In another embodiment, actuator 504 is configured to actuate computer-controlled machine 500 based directly on output signals y.

Upon receipt of actuator control commands 510 by actuator 504, actuator 504 is configured to execute an action corresponding to the related actuator control command 510. Actuator 504 may include a control logic configured to transform actuator control commands 510 into a second actuator control command, which is utilized to control actuator 504. In one or more embodiments, actuator control commands 510 may be utilized to control a display instead of or in addition to an actuator.

In another embodiment, control system 502 includes sensor 506 instead of or in addition to computer-controlled machine 500 including sensor 506. Control system 502 may also include actuator 504 instead of or in addition to computer-controlled machine 500 including actuator 504.

As shown in FIG. 5, control system 502 also includes processor 520 and memory 522. Processor 520 may include one or more processors. Memory 522 may include one or more memory devices. The classifier 514 (e.g., machine-learning algorithms, such as those described above with regard to pre-trained classifier 306) of one or more embodiments may be implemented by control system 502, which includes non-volatile storage 516, processor 520 and memory 522.

Non-volatile storage 516 may include one or more persistent data storage devices such as a hard drive, optical drive, tape drive, non-volatile solid-state device, cloud storage or any other device capable of persistently storing information. Processor 520 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 522. Memory 522 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 520 may be configured to read into memory 522 and execute computer-executable instructions residing in non-volatile storage 516 and embodying one or more ML algorithms and/or methodologies of one or more embodiments. Non-volatile storage 516 may include one or more operating systems and applications. Non-volatile storage 516 may store compiled and/or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

Upon execution by processor 520, the computer-executable instructions of non-volatile storage 516 may cause control system 502 to implement one or more of the ML algorithms and/or methodologies as disclosed herein. Non-volatile storage 516 may also include ML data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

FIG. 6 depicts a schematic diagram of control system 502 configured to control vehicle 600, which may be an at least partially autonomous vehicle or an at least partially autonomous robot. Vehicle 600 includes actuator 504 and sensor 506. Sensor 506 may include one or more video sensors, cameras, radar sensors, ultrasonic sensors, LiDAR sensors, and/or position sensors (e.g. GPS). One or more of the one or more specific sensors may be integrated into vehicle 600. In the context of sign-recognition and processing as described herein, the sensor 506 is a camera mounted to or integrated into the vehicle 600. Alternatively or in addition to one or more specific sensors identified above, sensor 506 may include a software module configured to, upon execution, determine a state of actuator 504. One non-limiting example of a software module includes a weather information software module configured to determine a present or future state of the weather proximate vehicle 600 or other location.

Classifier 514 of control system 502 of vehicle 600 may be configured to detect objects in the vicinity of vehicle 600 dependent on input signals x. In such an embodiment, output signal y may include information characterizing the vicinity of objects to vehicle 600. Actuator control command 510 may be determined in accordance with this information. The actuator control command 510 may be used to avoid collisions with the detected objects.

In embodiments where vehicle 600 is an at least partially autonomous vehicle, actuator 504 may be embodied in a brake, a propulsion system, an engine, a drivetrain, or a steering of vehicle 600. Actuator control commands 510 may be determined such that actuator 504 is controlled such that vehicle 600 avoids collisions with detected objects. Detected objects may also be classified according to what classifier 514 deems them most likely to be, such as pedestrians or trees. The actuator control commands 510 may be determined depending on the classification. In a scenario where an adversarial attack may occur, the system described above may be further trained to better detect objects or identify a change in lighting conditions or an angle for a sensor or camera on vehicle 600.

In other embodiments where vehicle 600 is an at least partially autonomous robot, vehicle 600 may be a mobile robot that is configured to carry out one or more functions, such as flying, swimming, diving and stepping. The mobile robot may be an at least partially autonomous lawn mower or an at least partially autonomous cleaning robot. In such embodiments, the actuator control command 510 may be determined such that a propulsion unit, steering unit and/or brake unit of the mobile robot may be controlled such that the mobile robot may avoid collisions with identified objects.

In another embodiment, vehicle 600 is an at least partially autonomous robot in the form of a gardening robot. In such embodiment, vehicle 600 may use an optical sensor as sensor 506 to determine a state of plants in an environment proximate vehicle 600. Actuator 504 may be a nozzle configured to spray chemicals. Depending on an identified species and/or an identified state of the plants, actuator control command 510 may be determined to cause actuator 504 to spray the plants with a suitable quantity of suitable chemicals.

Vehicle 600 may be an at least partially autonomous robot in the form of a domestic appliance. Non-limiting examples of domestic appliances include a washing machine, a stove, an oven, a microwave, or a dishwasher. In such a vehicle 600, sensor 506 may be an optical sensor configured to detect a state of an object which is to undergo processing by the household appliance. For example, in the case of the domestic appliance being a washing machine, sensor 506 may detect a state of the laundry inside the washing machine. Actuator control command 510 may be determined based on the detected state of the laundry.

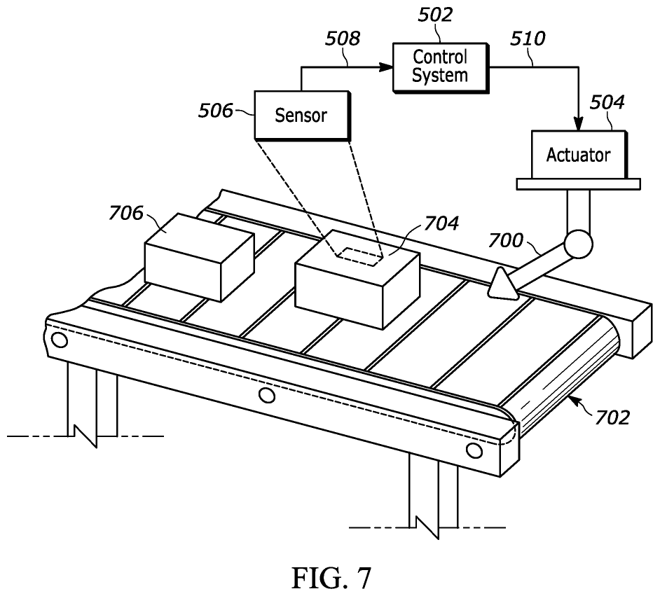

FIG. 7 depicts a schematic diagram of control system 502 configured to control system 700 (e.g., manufacturing machine), such as a punch cutter, a cutter or a gun drill, of manufacturing system 702, such as part of a production line. Control system 502 may be configured to control actuator 504, which is configured to control system 700 (e.g., manufacturing machine).

Sensor 506 of system 700 (e.g., manufacturing machine) may be an optical sensor configured to capture one or more properties of manufactured product 704. Classifier 514 may be configured to determine a state of manufactured product 704 from one or more of the captured properties. Actuator 504 may be configured to control system 700 (e.g., manufacturing machine) depending on the determined state of manufactured product 704 for a subsequent manufacturing step of manufactured product 704. The actuator 504 may be configured to control functions of system 700 (e.g., manufacturing machine) on subsequent manufactured product 106 of system 700 (e.g., manufacturing machine) depending on the determined state of manufactured product 704.

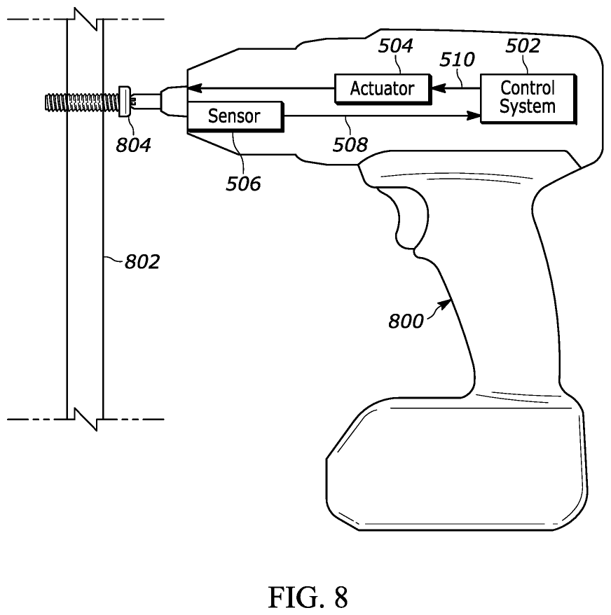

FIG. 8 depicts a schematic diagram of control system 502 configured to control power tool 800, such as a power drill or driver, that has an at least partially autonomous mode. Control system 502 may be configured to control actuator 504, which is configured to control power tool 800.

Sensor 506 of power tool 800 may be an optical sensor configured to capture one or more properties of work surface 802 and/or fastener 804 being driven into work surface 802. Classifier 514 may be configured to determine a state of work surface 802 and/or fastener 804 relative to work surface 802 from one or more of the captured properties. The state may be fastener 804 being flush with work surface 802. The state may alternatively be hardness of work surface 802. Actuator 504 may be configured to control power tool 800 such that the driving function of power tool 800 is adjusted depending on the determined state of fastener 804 relative to work surface 802 or one or more captured properties of work surface 802. For example, actuator 504 may discontinue the driving function if the state of fastener 804 is flush relative to work surface 802. As another non-limiting example, actuator 504 may apply additional or less torque depending on the hardness of work surface 802.

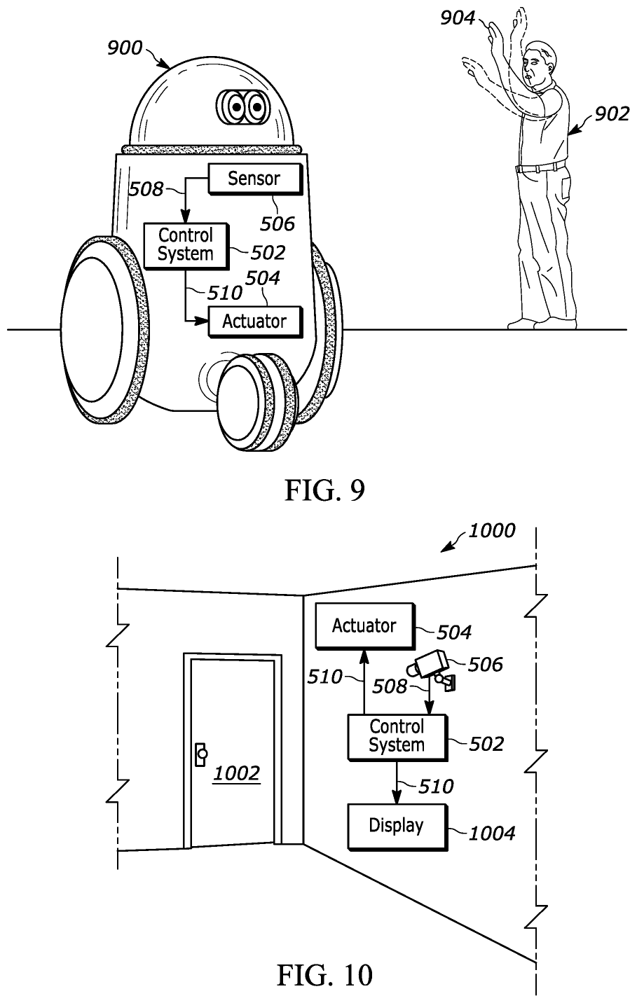

FIG. 9 depicts a schematic diagram of control system 502 configured to control automated personal assistant 900. Control system 502 may be configured to control actuator 504, which is configured to control automated personal assistant 900. Automated personal assistant 900 may be configured to control a domestic appliance, such as a washing machine, a stove, an oven, a microwave or a dishwasher.

Sensor 506 may be an optical sensor and/or an audio sensor. The optical sensor may be configured to receive video images of gestures 904 of user 902. The audio sensor may be configured to receive a voice command of user 902.

Control system 502 of automated personal assistant 900 may be configured to determine actuator control commands 510 configured to control system 502. Control system 502 may be configured to determine actuator control commands 510 in accordance with sensor signals 508 of sensor 506. Automated personal assistant 900 is configured to transmit sensor signals 508 to control system 502. Classifier 514 of control system 502 may be configured to execute a gesture recognition algorithm to identify gesture 904 made by user 902, to determine actuator control commands 510, and to transmit the actuator control commands 510 to actuator 504. Classifier 514 may be configured to retrieve information from non-volatile storage in response to gesture 904 and to output the retrieved information in a form suitable for reception by user 902.

FIG. 10 depicts a schematic diagram of control system 502 configured to control monitoring system 1000. Monitoring system 1000 may be configured to physically control access through door 1002. Sensor 506 may be configured to detect a scene that is relevant in deciding whether access is granted. Sensor 506 may be an optical sensor configured to generate and transmit image and/or video data. Such data may be used by control system 502 to detect a person's face.

Classifier 514 of control system 502 of monitoring system 1000 may be configured to interpret the image and/or video data by matching identities of known people stored in non-volatile storage 516, thereby determining an identity of a person. Classifier 514 may be configured to generate and an actuator control command 510 in response to the interpretation of the image and/or video data. Control system 502 is configured to transmit the actuator control command 510 to actuator 504. In this embodiment, actuator 504 may be configured to lock or unlock door 1002 in response to the actuator control command 510. In other embodiments, a non-physical, logical access control is also possible.

Monitoring system 1000 may also be a surveillance system. In such an embodiment, sensor 506 may be an optical sensor configured to detect a scene that is under surveillance and control system 502 is configured to control display 1004. Classifier 514 is configured to determine a classification of a scene, e.g. whether the scene detected by sensor 506 is suspicious. Control system 502 is configured to transmit an actuator control command 510 to display 1004 in response to the classification. Display 1004 may be configured to adjust the displayed content in response to the actuator control command 510. For instance, display 1004 may highlight an object that is deemed suspicious by classifier 514. Utilizing an embodiment of the system disclosed, the surveillance system may predict objects at certain times in the future showing up.

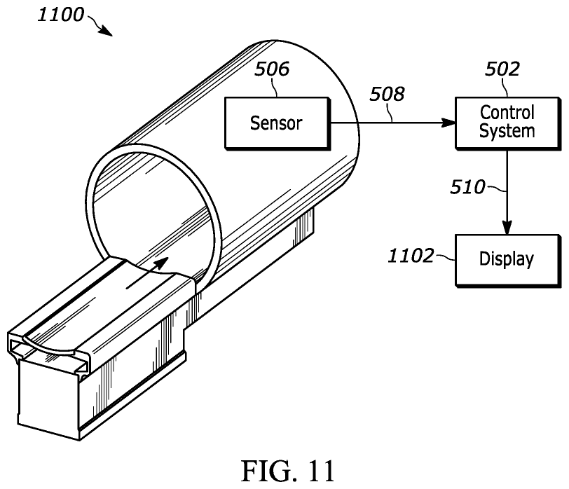

FIG. 11 depicts a schematic diagram of control system 502 configured to control imaging system 1100, for example an MRI apparatus, x-ray imaging apparatus or ultrasonic apparatus. Sensor 506 may, for example, be an imaging sensor. Classifier 514 may be configured to determine a classification of all or part of the sensed image. Classifier 514 may be configured to determine or select an actuator control command 510 in response to the classification obtained by the trained neural network. For example, classifier 514 may interpret a region of a sensed image to be potentially anomalous. In this case, actuator control command 510 may be determined or selected to cause display 1102 to display the imaging and highlighting the potentially anomalous region.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A computer-implemented method for attacking a neural network, comprising:
receiving an input data, wherein the input data includes at least an image and a corresponding ground truth label;
adding a pre-determined amount of noise to the image to create a noisy image;
denoising the noisy image utilizing a diffusion model that includes a deep equilibrium root solver configured to generate a denoised image;
determining a first gradient of the denoised image with respect to the input data including at least the image, wherein the first gradient is associated with the diffusion model;
utilizing the denoised image at downstream model of the neural network, outputting a predicated label associated with the denoised image;
determining a loss utilizing with the predicted label and the ground truth label;
determining a second gradient associated with the downstream model utilizing at least the loss; and
outputting an aggregate gradient that represents an error of the neural network output utilizing the predicted label, wherein the aggregate gradient is calculated utilizing at least the first gradient and the second gradient.

2. The computer-implemented method of claim 1, wherein the diffusion model includes a denoising diffusion implicit model.

3. The computer-implemented method of claim 1, wherein the first gradient is determined not utilizing back propagation through an iterative denoising process.

4. The computer-implemented method of claim 1, wherein denoising is not done sequentially via the diffusion model.

5. The computer-implemented method of claim 1, wherein a damping factor is utilized in calculating the first gradient.

6. The computer-implemented method of claim 5, wherein convergence is improved in response to increasing the damping factor.

7. The computer-implemented method of claim 1, wherein the first gradient is calculated utilizing x*_{0:T}=τ·\tilde{h}(x*_{0:T-1})+(1−τ)·x*_{0:T}.

8. The computer-implemented method of claim 1, wherein the aggregate gradient is determined utilizing backpropagation.

9. The computer-implemented method of claim 1, wherein the downstream model of the neural network is a pretrained model.

10. The computer-implemented method of claim 1, wherein the input data includes at least an image and corresponding label.

11. A system comprising:
a controller configured to:
receive an input data, wherein the input data includes at least an image and a corresponding ground truth label;
add a noise to the image to create a noisy image;
denoise the noisy image utilizing a diffusion model that includes a deep equilibrium root solver configured to generate a denoised image;
determine a first gradient of the denoised image, wherein the first gradient is associated with the diffusion model;
utilizing the denoised image at downstream model of the neural network, output a predicated label associated with the denoised image;
determine a loss utilizing the predicted label and the ground truth label;
determine a second gradient associated with the downstream model utilizing at least the loss; and
output an aggregate gradient that represents an error of the neural network output utilizing the predicted label, wherein the gradient is calculated utilizing at least the first gradient and the second gradient.

12. The system of claim 11, wherein the image includes at least video data, picture data, or sound data.

13. The system of claim 11, wherein the deep equilibrium root solver utilizes Anderson acceleration to generate the denoised image.

14. The system of claim 11, wherein the aggregate gradient is utilized to generate one or more adversarial examples at the neural network that maximize a loss function of the neural network.

15. The system of claim 11, wherein a damping factor is utilized in determining the first gradient.

16. A computer-implemented method for attacking a neural network, comprising:
receiving an image;
adding a pre-determined amount of noise to the image to create a noisy image;
denoising the noisy image utilizing a diffusion model that includes a deep equilibrium root solver configured to generate a denoised image;
determining a first gradient of the denoised image, wherein the first gradient is associated with the diffusion model;
utilizing the denoised image at downstream model of the neural network, outputting a predicated label associated with the denoised image;
determining a loss utilizing at least the predicted label;
determining a second gradient associated with the downstream model utilizing at least the loss; and
outputting an aggregate gradient that represents an error of the neural network output utilizing the predicted label, wherein the gradient is calculated utilizing at least the first gradient and the second gradient.

17. The method of claim 16, wherein the deep equilibrium root solver utilizes Anderson acceleration to generate the denoised image.

18. The method of claim 16, wherein the aggregate gradient is utilized to generate one or more adversarial examples at the neural network that maximize a loss function of the neural network.

19. The method of claim 16, wherein the downstream model of the neural network is an untrained model.

20. The method of claim 16, wherein denoising the noisy image includes utilizing a stochastic approach that adds extra noise at each denoising step.
